(19) United States
(12) Patent Application Publication
(10) Pub. No.: US 2026/0152879 A1
(43) Pub. Date: Jun. 4, 2026

(54) CARBON NANOTUBE FIBER AND METHOD FOR MANUFACTURING THE SAME

(71) Applicants: HYUNDAI MOTOR COMPANY, Seoul (KR); Kia Corporation, Seoul (KR); KOREA INSTITUTE OF SCIENCE AND TECHNOLOGY, Seoul (KR)

(72) Inventors: Gwan Sik KIM, Hwaseong-si (KR); Dong Gu KIM, Hwaseong-si (KR); Deok Woo YUN, Hwaseong-si (KR); Jang Hyeon LEE, Hwaseong-si (KR); Kyong Hwa SONG, Hwaseong-si (KR); Seok Min LEE, Hwaseong-si (KR); Seung Min KIM, Seoul (KR); Min Gook HAN, Wanju_gun (KR); Hyeon Su JEONG, Daejeon (KR)

(21) Appl. No.: 19/200,088

(22) Filed: May 6, 2025

(30) Foreign Application Priority Data
Dec. 4, 2024 (KR) 10-2024-0178821

(51) Int. Cl. D02G 3/02; D01F 9/12; D01F 11/12; D02G 3/28; D02G 3/44

(52) U.S. Cl. CPC D02G 3/02; D01F 9/12; D01F 11/121; D02G 3/28; D02G 3/441; D10B 2401/063; D10B 2401/16

(57) ABSTRACT

A carbon nanotube fiber is formed by aggregating carbon nanotube bundles. An axial direction of each of the carbon nanotube bundles of the formed carbon nanotube fiber forms an angle that is less than or equal to 10 degrees with respect to an axial direction of the carbon nanotube fiber. The carbon nanotube fiber has a cross-sectional aspect ratio of greater than or equal to 1.0 and less than or equal to 1.25.

### CROSS-REFERENCE TO RELATED APPLICATION

This application claims priority to Korean Patent Application No. 10-2024-0178821, filed on Dec. 4, 2024, the disclosure of which is incorporated herein by reference in its entirety.

### TECHNICAL FIELD

The present disclosure relates to a carbon nanotube fiber having a large diameter, high density, and high electrical conductivity to be widely applied in industrial fields, and a method for manufacturing the same.

### BACKGROUND

Carbon nanotubes have drawn attention for application in various industrial fields, due to their excellent mechanical strength and electrical conductivity. In particular, a carbon nanotube fiber, which is obtained by forming carbon nanotubes in the form of a fiber, has the potential to be extensively employed in various fields, such as an electronic material, an energy storage device, and a higher strength composite material, due to the inherent physical properties of the carbon nanotube fiber.

### SUMMARY

In some examples, the diameter, density, and alignment of the carbon nanotube fiber may be important factors in maximizing the performance of the carbon nanotube fiber.

In general, a carbon nanotube fiber having a lower diameter may exhibit higher mechanical and electrical performance, because inner pores may be minimized and the purity of the carbon nanotube fiber and the quality of a single carbon nanotube may be more precisely controlled. However, a carbon nanotube having a larger diameter may often need to endure a higher load or a lower resistance in an actual industrial field. To meet such need, a large number of carbon nanotube fibers may be bundled or a large-diameter single carbon nanotube fiber may be implemented.

Accordingly, in some instances of manufacturing a carbon nanotube fiber, a wet spinning process may exhibit a problem in that performance may be degraded because pores may be easily formed in the carbon nanotube fiber when a large-diameter carbon nanotube fiber is manufactured. Moreover, a plying process has difficulty in implementing a high-performance fiber because pores are formed in the carbon nanotube due to its simple twisted structure. Accordingly, there may be a need to develop a carbon nanotube fiber having a larger diameter and higher density.

The present disclosure addresses the issues described above.

An aspect of the present disclosure provides a carbon nanotube fiber that exhibits a high density, large diameter, and high electrical conductivity, and a method for manufacturing the same.

More specifically, implementations according to this disclosure provides a carbon nanotube fiber that is formed by aggregating a plurality of carbon nanotube bundles, in which an axial direction of the carbon nanotube bundle can form an angle of at most 10° with respect to an axial direction of the carbon nanotube fiber, and an aspect ratio of a cross-section of the carbon nanotube fiber can range from 1.0 to 1.25.

In some implementations, the carbon nanotube fiber has a minimum diameter that ranges from 200 μm to 1000 μm.

In some implementations, the carbon nanotube fiber has a density that ranges from 0.5 g/cm³ to 2 g/cm³.

In some implementations, the carbon nanotube fiber has a tex value (mass per length) that ranges from 10 and to 90.

In some implementations, the carbon nanotube fiber has an electrical conductivity that ranges from 1.105 S/m to 1·10⁷ S/m.

In some implementations, the carbon nanotube fiber has a specific electrical conductivity that ranges from 1,000 S·m²/kg to 2,500 S·m²/kg. For instance, the specific electrical conductivity can be determined by dividing a length of the carbon nanotube fiber by a product of resistance and linear density of the carbon nanotube fiber.

In some implementations, the carbon nanotube fiber has a specific tensile strength that ranges from 0.5 N/tex to 1.0 N/tex. For instance, the specific tensile strength can be determined by dividing a tensile force of the carbon nanotube fiber by a linear density of the carbon nanotube fiber.

Another aspect of the present disclosure provides a method for manufacturing a carbon nanotube fiber, which includes manufacturing a low-diameter single carbon nanotube fiber having a minimum diameter which ranges from 50 μm to 400 μm, manufacturing a large-diameter carbon nanotube fiber having a minimum diameter which ranges from 200 μm to 1000 μm by plying the low-diameter single carbon nanotube fiber, and aggregating the large-diameter carbon nanotube fiber.

In some implementations, a ratio of a linear density of the carbon nanotube fiber to a linear density of a large-diameter single carbon nanotube fiber ranges from 0.3 to 0.9.

In some implementations, a tex value of the low-diameter single carbon nanotube fiber ranges from 3 to 15.

In some implementations, plying the low-diameter single carbon nanotube fiber includes plying 2 to 14 strands of low-diameter single carbon nanotube fibers.

In some implementations, aggregating the large-diameter carbon nanotube fiber includes immersing the carbon nanotube fiber into an acid solution.

In some implementations, immersing the carbon nanotube fiber into the acid solution can be performed for a time ranging one minute to five minutes.

In some implementations, the method for manufacturing the carbon nanotube fiber can further include stretching, solidifying, and drying the carbon nanotube fiber after immersing the carbon nanotube fiber.

### BRIEF DESCRIPTION OF THE DRAWINGS

FIG. 1A illustrates an image obtained by photographing, through a Scanning Electron Microscope (SEM), a portion of an example of a carbon nanotube fiber.

FIG. 1B illustrates an image obtained by photographing, through a X-ray microscope (XRM), a portion of an example of a carbon nanotube fiber.

FIGS. 2A and 2B illustrate images obtained by photographing, through an XRM, cross-sections of surfaces perpendicular to an axial direction of examples of carbon nanotube fibers.

FIGS. 3A and 3B illustrate images obtained by photographing, through an SEM, portions of examples of carbon nanotube fibers.

FIGS. 4A and 4B illustrate images obtained by photographing, through an SEM, cross-sections of examples of carbon nanotube fibers.

### DETAILED DESCRIPTION

In the present disclosure, the terminology a “carbon nanotube bundle” can refer to a secondary structure formed by aggregating the unit cell of a carbon nanotube in the form of a bundle. Moreover, the term “carbon nanotube bundle” can also include its conventionally understood meaning in the field.

In the present disclosure, the terminology a “carbon nanotube fiber” can collectively indicate a structure formed by growing a carbon nanotube in the form of a fiber or a structure formed by aggregating a plurality of carbon nanotubes in the form of a fiber. Moreover, the term “carbon nanotube fiber” carbon nanotube bundle can also include its conventionally understood meaning in the field.

In the present disclosure, a “low-diameter single carbon nanotube fiber” can indicate a structure formed by aggregating a plurality of carbon nanotube bundles in the form of a fiber.

In the present disclosure, a “large-diameter single carbon nanotube fiber” can indicate a structure formed by aggregating a plurality of low-diameter single carbon nanotube fibers in the form of a fiber.

In the present disclosure, a “specific electrical conductivity” can refer to an electrical conductivity to a linear density of the carbon nanotube fiber, and can be calculated by dividing a measurement length by the product of a resistance and a linear density.

### Carbon Nanotube Fiber

The present disclosure provides a carbon nanotube fiber formed by aggregating a plurality of carbon nanotube bundles, in which an axial direction of the carbon nanotube bundle forms an angle of at most 10° with respect to an axial direction of the carbon nanotube fiber, and an aspect ratio of a cross-section of the carbon nanotube fiber ranges 1.0 to 1.25.

Hereinafter, a carbon nanotube fiber according to the present disclosure will be described in detail.

The carbon nanotube fiber according to the present disclosure can be formed by aggregating a plurality of carbon nanotube bundles, and the axial direction of the carbon nanotube bundle can form an angle of at most 10°, at most 9°, at most 8°, at most 7°, or at most 6°, at most 5° with respect to the axial direction of the carbon nanotube fiber, and the aspect ratio of the cross section of the carbon nanotube fiber can be at least 1.0, at least 1.01, at least 1.02, at least 1.03, at least 1.04, and at most 1.25, at most 1.20, at most 1.15, or at most 1.10.

As the carbon nanotube fiber satisfies the characteristic, even though the carbon nanotube fiber is formed by aggregating the plurality of carbon nanotube bundles, a larger porous structure is not formed between the carbon nanotube bundles. Accordingly, the density of the carbon nanotube fiber can be increased, so even the electrical conductivity can be increased. In addition, since the carbon nanotube fiber can exhibit the form of a single carbon nanotube fiber, the carbon nanotube fiber exhibits excellent mechanical and electrical properties. Accordingly, the carbon nanotube fiber can be applied to various industrial fields.

According to the present disclosure, the axial direction of the carbon nanotube can refer to a direction in which carbon nanotube fibers are arranged in a longitudinal direction, and a cross-section of the carbon nanotube fiber can refer to a cross-section in a direction perpendicular to the axial direction of the carbon nanotube.

In some implementations, the minimum diameter of the carbon nanotube fiber can range from 200 μm to 1000 μm, and preferably can range from 200 μm to 900 μm. As the diameter of the carbon nanotube fiber satisfies the above range, the carbon nanotube fiber can withstand higher loads and exhibit improved resistance characteristics when used in industrial fields. In addition, the carbon nanotube fiber can exhibit thermal conductivity and excellent lifespan characteristics.

In some implementations, the density of the carbon nanotube fiber can range from 0.5 g/cm³ to 2 g/cm³, and can preferably range from 0.8 g/cm³ to 1.8 g/cm³. As the density of the carbon nanotube fiber satisfies the above range, the characteristic of the higher density can be implemented in the carbon nanotube fiber. Accordingly, the carbon nanotube fiber can exhibit a higher electrical conductivity. In addition, the carbon nanotube fiber can exhibit tensile strength and durability increased. In addition, the internal pores of the carbon nanotube fiber can be minimized, thereby increasing the electrical efficiency.

In some implementations, the Tex (mass per length) of the carbon nanotube fiber can be at least 10 and at most 90, and preferably can be at least 15, at least 20, at least 25, at least 30, or at least 35, and at most 85, at most 80, at most 75, at most 70, at most 65, at most 60, at most 55, at most 50, or at most 45. As the Tex of the carbon nanotube fiber satisfies the above range, the carbon nanotube fiber can exhibit tensile strength and elasticity which are optimized, and a higher electrical conductivity, and maintain uniform heat distribution and thermal conductivity.

In some implementations, the electrical conductivity of the carbon nanotube fiber can range from 1.105 S/m to 1·10⁷ S/m and preferably can range from 1.106 S/m to 8.106 S/m. When the electrical conductivity of the carbon nanotube fiber satisfies the above range, the carbon nanotube fiber can be suitable for use in an energy storage device, or an electrode, as a current can be efficiently transmitted in the carbon nanotube fiber. In addition, when the current flows, heat radiation from a resistor can be reduced, so the carbon nanotube fiber can exhibit improved thermal stability.

In some implementations, the specific electrical conductivity of the carbon nanotube fiber can range from 1,000 S·m²/kg to 2,500 S·m²/kg, and preferably can be at least 1,100 S·m²/kg, at least 1,200 S·m²/kg, at least 1,300 S·m²/kg, or at least 1,400 S·m²/kg, and at most 2,400 S·m²/kg, at most 2,300 S·m²/kg, at most 2,200 S·m²/kg, at most 2,100 S·m²/kg, at most 2,000 S·m²/kg, at most 1,900 S·m²/kg, or at most 1,800 S·m²/kg. When the specific electrical conductivity of the carbon nanotube fiber satisfies the above range, the carbon nanotube fiber can be suitable for use in an energy storage device, or an electrode, as a current can be efficiently transmitted in the carbon nanotube fiber. In addition, when the current flows, heat radiation from a resistor can be reduced, so the carbon nanotube fiber can exhibit improved thermal stability.

In some implementations, the specific tensile strength of the carbon nanotube fiber can be at least 0.5 N/tex and at most 1.0 N/tex, and preferably at least 0.52 N/tex, at least 0.54 N/tex, at least 0.56 N/tex, at least 0.58 N/tex, or at least 0.60 N/tex, and can be at most 1.0 N/tex, at most 0.95 N/tex, at most 0.90 N/tex, at most 0.8 5N/tex, or at most 0.80 N/tex. The specific tensile strength of the carbon nanotube fiber satisfying the above range can exhibit higher strength, thereby contributing to improving energy efficiency, and can exhibit higher resistance to external impact or deformation, thereby increasing in the lifespan of the carbon nanotube fiber.

### Method for Manufacturing Carbon Nanotube Fiber

The present disclosure provides a method for manufacturing carbon nanotube fiber, which includes the step for manufacturing a low-diameter single carbon nanotube fiber having a minimum diameter which ranges from 50 μm to 400 μm (S1), manufacturing a large-diameter carbon nanotube fiber having a minimum diameter which ranges from 200 μm to 1,000 μm by plying the low-diameter single carbon nanotube fiber (S2), and aggregating the large-diameter carbon nanotube fiber (S3).

Hereinafter, the method for manufacturing the carbon nanotube fiber according to the present disclosure will be described in detail.

### Manufacturing (S1) of Low-Diameter Single Carbon Nanotube Fiber

According to the present disclosure, ‘S1’ can be the step for manufacturing the low-diameter single carbon nanotube fiber using individual carbon nanotube bundles.

The manufacturing of the low-diameter single carbon nanotube fiber can be performed through a direct spinning manner. The direct spinning manner for manufacturing the low-diameter single carbon nanotube fiber can include synthesizing individual carbon nanotube bundles using a chemical vapor deposition (CVD) manner, spinning the carbon nanotube bundles, and then aggregating the carbon nanotube bundles in the form of a fiber. When the manufacturing of the low-diameter single carbon nanotube fiber is performed through the direct spinning manner, the diameter of the low-diameter single carbon nanotube fiber can be larger than a diameter of a low-diameter single carbon nanotube fiber manufactured through another manner.

The minimum diameter of the low-diameter single carbon nanotube fiber manufactured in the present step can range from 50 μm to 400 μm, and preferably range from 100 μm to 300 μm. When the minimum diameter of the low-diameter single carbon nanotube fiber satisfies the above range, the carbon nanotube fiber manufactured thereafter can have a lager diameter and the basic tensile strength of the carbon nanotube fiber can be ensured, thereby increasing industrial application.

The Tex of the low-diameter single carbon nanotube fiber can range from 3 to 15, and preferably can range from 4 to 12. When the tex of the low-diameter single carbon nanotube fiber satisfies the above range, the carbon nanotube fiber manufactured thereafter can have a greater linear density, and the basic tensile strength of the carbon nanotube fiber can be ensured, thereby increasing industrial application.

### Manufacturing (S2) of Large-Diameter Carbon Nanotube Fiber

According to the present disclosure, ‘S2’ is the step for manufacturing the large-diameter carbon nanotube fiber by plying a plurality of low-diameter single carbon nanotube fibers manufactured in ‘S1’.

As the present step is performed, the low-diameter single carbon nanotube fibers can be plied to manufacture the large-diameter carbon nanotube fiber, thereby increasing strength characteristics and electrical conductivity. Specifically, the ply can be formed by twisting several strands of low-diameter single carbon nanotube fibers.

The ply can be formed by plying two to 14 strands of low-diameter single carbon nanotube fibers, and preferably, four to 12 strands of low-diameter single carbon nanotube fibers. The number of low-diameter single carbon nanotube fibers satisfying the above range can make it possible to ensure a thickness suitable for industrial standardization, and can be suitable for introduction into the subsequent aggregating process. In addition, the large-diameter carbon nanotube fiber after the above plying can have a minimum diameter ranging from 200 μm to 1,000 μm, preferably ranging from 300 μm to 900 μm.

### Aggregating (S3)

According to the present disclosure, ‘S3’ can be the step for aggregating the carbon nanotube fiber after the plying process to remove air pores in the carbon nanotube fiber, and ensure the alignment of the carbon nanotube fiber such that the diameter of the carbon nanotube fiber is reduced.

Specifically, the aggregating according to the present disclosure can include immersing the carbon nanotube fiber in an acid solution to swell and stretch the carbon nanotube fiber, and solidifying and drying the stretched carbon nanotube fiber.

The immersing can be a process for causing the carbon nanotube fiber to be swollen, and the stretching can be a process of applying tensile strength to the carbon nanotube fiber through a winding device. After the stretching process, the carbon nanotube fiber can be aligned and rearranged in the axial direction of the carbon nanotube fiber.

The acid solution used in the immersing can include at least one selected from the group consisting of chlorosulfuric acid (HSO₃Cl), fluorosulfuric acid (HSO₃F), trifluoroacetic acid (CF₃COOH), trifluoromethanesulfonic acid (CF₃SO₃H), fluoroantimonic acid (H₂FSbF₆), and carborane acid, and preferably chlorosulfuric acid (HSO₃Cl). When the type of acid solution is appropriately selected, the carbon nanotube fiber can be smoothly swollen. In some implementations, other types of acid solutions may also be used.

In addition, the immersing can be performed for a time ranging from 1 minute to 10 minutes, preferably a time ranging from 1 minute to 5 minutes. When the immersing is performed for an appropriate time, the carbon nanotube fiber can be sufficiently swollen, and damage to the carbon nanotube fiber by the acid solution can be minimized.

The carbon nanotube fiber can have a stretching ratio ranging 0% to 200%, preferably 20% to 180%. When an appropriate stretching ratio is employed, productivity and mass production suitability can be increased without damage to the carbon nanotube fiber.

The solidifying can be performed by allowing the carbon nanotube fiber to pass through a solidifying solution, and an acid solution remaining inside the carbon nanotube fiber can be discharged through the solidifying process. In addition, the solidifying solution can include at least one selected from the group consisting of chloroform, acetonitrile, N, N-dimethylformamide, acetone, diethyl ether, and sulfuric acid fumes. In some implementations, other types of acid solutions may also be used.

The drying can be a process of drying the solidified carbon nanotube fiber to evaporate an acid solution therein, and the carbon nanotube fiber thus obtained can be in a dense state with micro-pores formed. The drying method is not particularly limited as long as it is a method capable of evaporating an acid solution.

The carbon nanotube fiber that has undergone the stretching and solidifying steps can have a diameter reduced by at least 2 times and at most 4 times compared to the large-diameter carbon nanotube fiber. Accordingly, the linear density can also be reduced by at least 10% and at most 40%.

Accordingly, the ratio of the linear density of the carbon nanotube fiber to the linear density of a large-diameter single carbon nanotube fiber can satisfy the range from 0.3 to 0.9, preferably, can satisfy the range from 0.4 to 0.7. When the ratio of the linear density of the carbon nanotube fiber to the linear density of the large-diameter single carbon nanotube fiber satisfies the range, the carbon nanotube fiber having the larger diameter and the higher density can be manufactured. Accordingly, the electrical conductivity of the carbon nanotube fiber can be improved.

Hereinafter, implementations of the present disclosure will be described in more detail. However, the following implementations are provided only for the illustrative purpose, and the scope of the present disclosure is not limited thereto.

### Implementation 1

Methane, ferrocene, thiophene, and hydrogen gas were introduced into a reactor and the low-diameter single carbon nanotube fiber having a minimum diameter of 100 μm was manufactured through the direct spinning manner. Thereafter, 12 strands of low-diameter single carbon nanotube fibers were plied, and the plied carbon nanotube fiber was immersed in chlorosulfuric acid for 2 minutes to obtain the carbon nanotube fiber through 170% of the stretching and solidifying processes.

### Implementation 2

The carbon nanotube fiber was obtained in a manner the same as a manner of Implementation 1, except that the plied carbon nanotube fiber was stretched by 150%.

### Implementation 3

The carbon nanotube fiber was obtained in a manner the same as a manner of Implementation 1, except that the plied carbon nanotube fiber was stretched by 120%.

### Comparative Example 1

Methane, ferrocene, thiophene, and hydrogen gas were introduced into a reactor and the single carbon nanotube fiber having a minimum diameter of 20 μm was manufactured through the direct spinning manner. Thereafter, single carbon nanotube fibers were plied in unit of three strands, and eight strands of plied carbon nanotube fibers were braided to obtain the final carbon nanotube fiber.

### Comparative Example 2

The carbon nanotube fiber was obtained in a manner the same as a manner of Implementation 1, except that any post-treatment process was not performed after the low-diameter single carbon nanotube fiber was plied.

### Experimental Example 1: Analysis of Alignment Characteristics of Carbon Nanotube Fiber

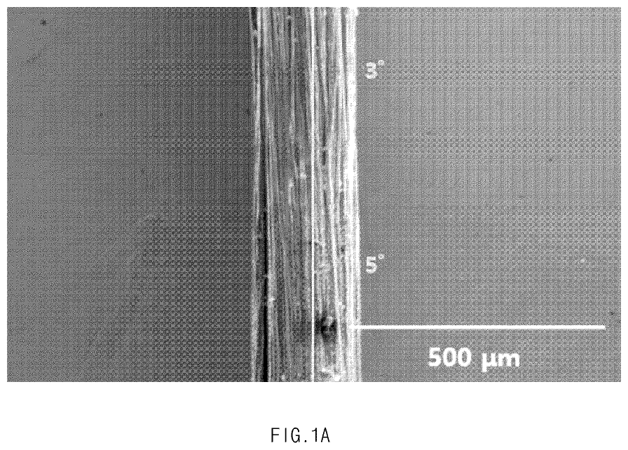

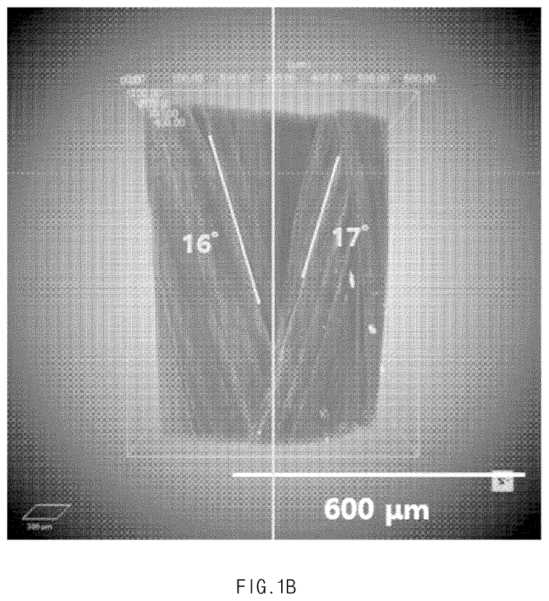

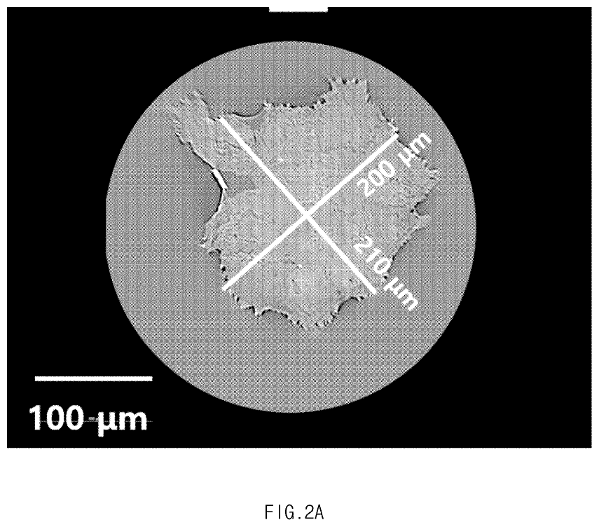

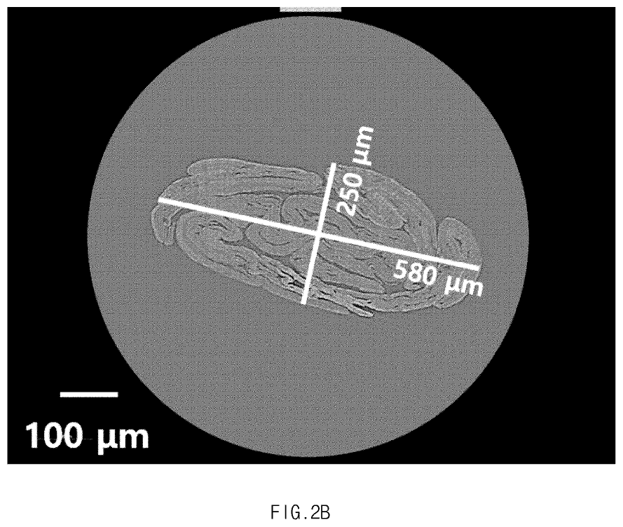

Images of portions of the carbon nanotube fibers were photographed through the SEM in Implementation 1, and through the XRM in Comparative example 1, to determine the alignment of the carbon nanotube fiber manufactured in Implementation 1 of the present disclosure and Comparative example 1, and the images are shown in FIGS. 1A and 1B. In addition, the cross-sections perpendicular to the axial direction of the carbon nanotube fibers according to Implementation 1 and Comparative example 1 were photographed as XRM images, and are shown in FIGS. 2A and 2B.

Referring to FIGS. 1A and 1B, it can be recognized that the carbon nanotube fiber according to an implementation of the present disclosure had a form formed by aggregating the plurality of carbon nanotube bundles, and the axial direction of the carbon nanotube bundles formed an angle of at most 10° with respect to the axial direction of the carbon nanotube fiber. To the contrary, it can be recognized that the carbon nanotube fiber according to a comparative example was seen to have a form in which several carbon nanotube bundles are twisted, and had an orientation angle of 15°. Accordingly, according to the present disclosure, it can be recognized that the structure forming a single fiber was obtained by uniformly aggregating several carbon nanotube bundles.

In addition, referring to FIGS. 2A and 2B, it can be recognized that the carbon nanotube fiber according to an implementation of the present disclosure had carbon nanotube bundles densely aligned such that large size air pores were not formed inside the carbon nanotube fiber. In addition, it can be recognized that the aspect ratio of the cross-section of the carbon nanotube fiber was calculated as 1.05, such that the shape of the cross-section approached a circle. To the contrary, it can be recognized that a plurality of air pores having a larger size were formed inside the carbon nanotube fiber according to the comparative example. In addition, it can be recognized that the aspect ratio of the cross-section of the carbon nanotube fiber was calculated as 2.0, such that the shape of the cross-section approached an ellipse.

### Experimental Example 2: Image Analysis of Carbon Nanotube Fiber According to Aggregating Process

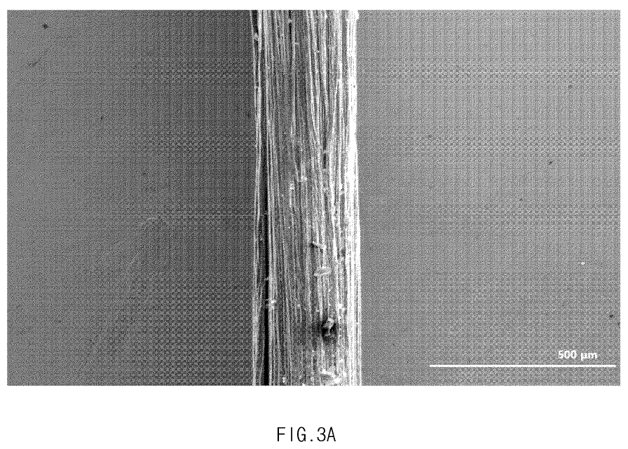

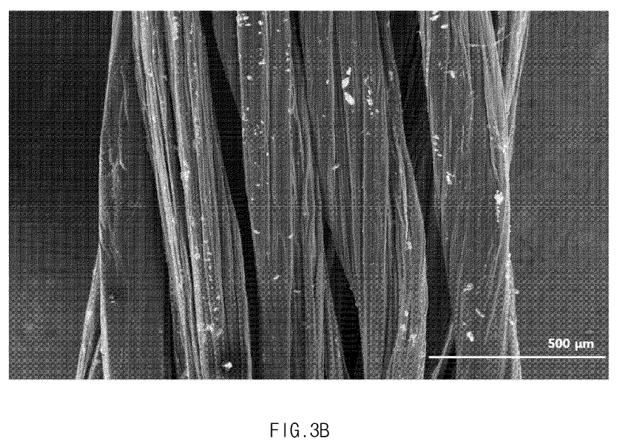

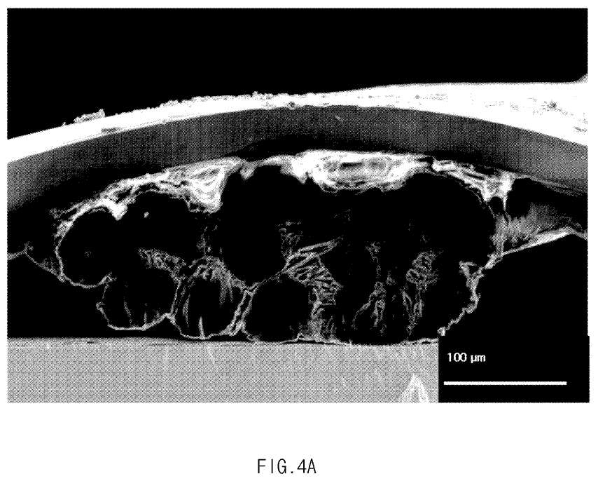

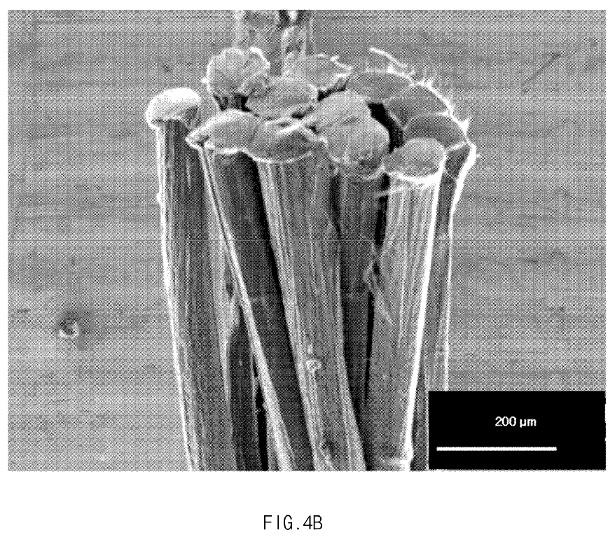

Images of portions of the carbon nanotube fibers manufactured according to Implementation 1 and Comparative example 2 were photographed as the SEM images and are shown in FIGS. 3A and 3B. In addition, the cross-sections of the carbon nanotube fiber were photographed as SEM images and are shown in FIGS. 4A and 4B.

Referring to FIGS. 3A and 3B, it can be recognized that the carbon nanotube fiber according to the present disclosure had the form of a single fiber, as compared to the large-diameter carbon nanotube obtained through a simple plying process, and had the diameter of about 200 μm through the aggregating process. In addition, referring to FIGS. 4A and 4B, it can be recognized that the carbon nanotube fiber according to the present disclosure had the form of a single fiber which rarely had air pores, through the aggregating process.

### Experimental Example 3: Measurement of Physical Properties of Carbon Nanotube Fiber

Values of a linear density (tex), a specific electrical conductivity (S·m²/kg), and a specific tensile strength (N/tex) of the carbon nanotube fiber manufactured according to an implementation and a Comparative example were in the following manner and are shown in Table 1.

### [Measurement Manner]

Linear density: After measuring the length of each sample using a ruler, the total length was calculated by adding the lengths of all samples. Thereafter, the weight of each sample was measured using Mettler Toledo's Microbalance scale, and the total weight was calculated. Accordingly, the linear density was calculated by dividing the total weight by the total length and by converting the result in a unit of g/km.

Specific electrical conductivity: A sample was placed in a longitudinal direction of a slide glass and fixed horizontally using a tape. Then, a silver paste was coated on the sample at the distance of 1 cm to form an electrode. Thereafter, two probes for supplying a current were brought into contact with opposite ends of the sample coated with the silver paste using MS Tech's MST-4000A probe station, and two probes for measuring resistances were spaced apart from each other by a distance of 2 cm while making contact with the sample. In this state, 100 μA of current was allowed to flow while the resistance of the sample was measured, by using a Keithley's source meter. Thereafter, to measure the linear density (tex) value, the weight of the sample having the length of 1 m was measured and converted into a value having the unit of g/km. Then, the average value of linear densities measured with respect to five samples in the same manner was calculated. Thereafter, the result was substituted into an equation of “measured length/(resistance*linear density) to obtain the specific electrical conductivity [S·m²/kg].

Specific tensile strength: After placing a sample on a paper holder having the length of 15 mm and fixing opposite ends of the sample using epoxy, epoxy was sufficiently dried such that the epoxy was completely cured, thereby preparing the sample. Thereafter, a tensile test was performed at the rate of 20 mm/min using Instron's universal testing machine 5567A to measure the physical strength. The physical strength measured in such a manner was divided by the linear density of the sample, thereby calculating the specific tensile strength.

TABLE 1

| | | Specific | Specific |
|---|---|---|---|
| | Linear | electrical | tensile |
| | density | Conductivity | strength |
| | [tex] | [S · m2/kg] | [N/tex] |
| Implementation | 36 | 1473.1 | 0.60 |
| 1 | | | |
| Implementation | 37 | 1366.59 | 0.69 |
| 2 | | | |
| Implementation | 41 | 1249.55 | 0.71 |
| 3 | | | |
| Comparative | 47 | 285.1 | 0.47 |
| Example 1 | | | |
| Comparative | 76 | 178.94 | 0.13 |
| Example 2 | | | |

Referring to Table 1, it can be recognized that the carbon nanotube fiber according to the present disclosure exhibited the linear density higher than the linear density of the carbon nanotube fiber according to Comparative example 1 which was obtained by twisting several carbon nanotube bundles and the carbon nanotube fiber according to Comparative example 2 obtained merely by plying several carbon nanotubes. In addition, it can be recognized that the characteristics of higher specific electrical conductivity and the higher specific tensile strength were exhibited due to the higher density characteristic.

As described above, the carbon nanotube fiber of the present disclosure has the form obtained by aggregating the plurality of carbon nanotube bundles. The axial direction of the carbon nanotube bundle forms an angle of at most 10° with respect to an axial direction of the carbon nanotube fiber, and the aspect ratio of the cross-section of the carbon nanotube fiber satisfies the condition of the range from 1.0 to 1.25. Accordingly, the carbon nanotube fiber having the higher density, in which the air pore structure is less formed, can be provided. Accordingly, as the carbon nanotube fiber having the larger diameter characteristic can exhibit the excellent electrical conductivity due to the higher density.

In addition, the method for manufacturing the carbon nanotube according to the present disclosure includes the aggregating process after the plying process to increase the cohesiveness of the carbon nanotube bundles. The carbon nanotube fiber according to the manufacturing method can exhibit the characteristics of the higher density, the larger diameter, and the excellent electrical conductivity.

Hereinabove, although the present disclosure has been described with reference to exemplary implementations and the accompanying drawings, the present disclosure is not limited thereto, but can be variously modified and altered by those skilled in the art to which the present disclosure pertains without departing from the spirit and scope of the present disclosure claimed in the following claims.

What is claimed is:

1. A carbon nanotube fiber having aggregated carbon nanotube bundles, the carbon nanotube fiber comprising:
a plurality of carbon nanotube bundles,
wherein an axial direction of each of the plurality of carbon nanotube bundles forms an angle that is less than or equal to 10 degrees with respect to an axial direction of the carbon nanotube fiber, and
wherein the carbon nanotube fiber has a cross-sectional aspect ratio of greater than or equal to 1.0 and less than or equal to 1.25.

2. The carbon nanotube fiber of claim 1, wherein the carbon nanotube fiber has a minimum diameter that is greater than or equal to 200 μm and less than or equal to 1000 μm.

3. The carbon nanotube fiber of claim 1, wherein the carbon nanotube fiber has a density that is greater than or equal to 0.5 g/cm³ and less than or equal to 2 g/cm³.

4. The carbon nanotube fiber of claim 1, wherein the carbon nanotube fiber has a tex value (mass in grams per 1000 meters) that is greater than or equal to 10 and less than or equal to 90.

5. The carbon nanotube fiber of claim 1, wherein the carbon nanotube fiber has an electrical conductivity that is greater than or equal to 1.105 S/m and less than or equal to 1·10⁷ S/m.

6. The carbon nanotube fiber of claim 1, wherein a specific electrical conductivity of the carbon nanotube fiber is greater than or equal to 1,000 S·m²/kg and less than or equal to 2,500 S·m²/kg, and
wherein the specific electrical conductivity is determined by dividing a length of the carbon nanotube fiber by a product of resistance and linear density of the carbon nanotube fiber.

7. The carbon nanotube fiber of claim 1, wherein a specific tensile strength of the carbon nanotube fiber is greater than or equal to 0.5 N/tex and less than or equal to 1.0 N/tex, and
wherein the specific tensile strength is determined by dividing a tensile force of the carbon nanotube fiber by a linear density of the carbon nanotube fiber.

8. A method for producing a carbon nanotube fiber, the method comprising:
producing a plurality of first carbon nanotube fibers with each carbon nanotube fiber having a minimum diameter that is greater than or equal to 50 μm and less than or equal to 400 μm;
producing one or more second carbon nanotube fibers with each second carbon nanotube fiber having a minimum diameter that is greater than or equal to 200 μm and less than or equal to 1,000 μm, wherein producing the one or more second carbon nanotube fibers comprises plying the two or more of the plurality of first carbon nanotube fibers; and
aggregating the one or more second carbon nanotube fibers.

9. The method of claim 8, wherein a ratio of a linear density of the carbon nanotube fiber to a linear density of each of the one or more second carbon nanotube fibers is greater than or equal to 0.3 and less than or equal to 0.9.

10. The method of claim 8, wherein each of the plurality of first carbon nanotube fibers has a tex value (mass in grams per 1000 meters) that is greater than or equal to 3 and less than or equal to 15.

11. The method of claim 8, wherein plying the two or more of the plurality of first carbon nanotube fibers comprises:
plying 2 to 14 strands from the plurality of first carbon nanotube fibers.

12. The method of claim 8, wherein aggregating the one or more second carbon nanotube fibers comprises:
immersing the one or more second carbon nanotube fibers in an acid solution.

13. The method of claim 12, wherein immersing the one or more second carbon nanotube fibers in the acid solution comprises:
immersing the one or more second carbon nanotube fibers in the acid solution for a duration that is greater than or equal to one minute and less than or equal to five minutes.

14. The method of claim 12, further comprising:
after immersing the one or more second carbon nanotube fibers in the acid solution and forming aggregated carbon nanotube fiber, stretching, solidifying, and drying the aggregated carbon nanotube fiber.

15. A method for producing a carbon nanotube fiber, the method comprising:
producing, based on plying a plurality of first carbon nanotube fibers, one or more second carbon nanotube fibers with each second carbon nanotube fiber having a minimum diameter that is greater than or equal to 200 μm and less than or equal to 1,000 μm, wherein each of the plurality of first carbon nanotube fibers has a minimum diameter that is greater than or equal to 50 μm and less than or equal to 400 μm; and
aggregating the one or more second carbon nanotube fibers to thereby form the carbon nanotube fiber.

16. The method of claim 15, wherein a ratio of a linear density of the carbon nanotube fiber to a linear density of each of the one or more second carbon nanotube fibers is greater than or equal to 0.3 and less than or equal to 0.9.

17. The method of claim 15, wherein each of the plurality of first carbon nanotube fibers has a tex value (mass in grams per 1000 meters) that is greater than or equal to 3 and less than or equal to 15.

18. The method of claim 15, wherein plying the plurality of first carbon nanotube fibers comprises:
plying 2 to 14 strands from the plurality of first carbon nanotube fibers.

19. The method of claim 15, wherein aggregating the one or more second carbon nanotube fibers comprises:
immersing the one or more second carbon nanotube fibers in an acid solution.

20. The method of claim 19, wherein immersing the one or more second carbon nanotube fibers in the acid solution comprises:
immersing the one or more second carbon nanotube fibers in the acid solution for a duration that is greater than or equal to one minute and less than or equal to five minutes.
